(19) United States
(12) Patent Application Publication
(10) Pub. No.: US 2005/0216282 A1
(43) Pub. Date: Sep. 29, 2005

(54) System and method for business object discovery

(75) Inventors: Shyh-Kwei Chen, Chappaqua, NY (US); Shiwa S. Fu, Irvington, NY (US); Yew-Huey Li, Yorktown Heights, NY (US); Revelino Pascual, New York, NY (US); Jih-Shyr Yih, Yorktown Heights, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/808,429

(22) Filed: Mar. 25, 2004

(51) Int. Cl. G06F 17/60

(52) U.S. Cl. 705/1

(57) ABSTRACT

A method and system discovers object definitions by receiving an object and a collaboration code, and determining an object definition for the object based upon the collaboration code.

### BACKGROUND OF THE INVENTION

1. Field of the Invention

The present invention relates to the field of business process integration and data integration. More particularly, the present invention relates to systems and methods for enhancing broker and adapter services and discovering mapping information for objects during runtime.

2. Description of the Related Art

Current system integration methods and systems, such as, for example, International Business Machines Corporation's Websphere Business Integration methods and systems, use objects (e.g. business objects) to carry data and processing instructions (e.g., mapping information and verbs).

A business object may be organized in a flat or hierarchical structure that conforms to a pre-defined business object definition (BOD). A business object may contain data, that is created at runtime, and may be an instance of a business object definition. Each business object definition may include a verb, such as retrieve, store, update, delete, and user defined verbs. The smallest entry or unit in a business object definition is a data attribute. In addition to structural information linking the list of data attributes, a business object definition maintains (for each data attribute) an attribute name, a data type, a cardinality indicator, its attribute length, and, most importantly, mapping information. The mapping information instructs an application adapter to create (or store) business objects from (or into) application data sources.

A business integration system may use business objects to carry data and processing instructions between an integration broker and connectors or an access client. Business objects may represent a request from an integration broker, an event in an application or Web server, or a call from an external site.

A business object definition can be generated manually via a designer GUI tool, or automatically via an object discovery agent (ODA) tool. A more detailed description of business objects is described in “IBM Websphere Business Integration Business Object Development Guide”, 2002, International Business Machines Corporation.

Conventional system integration methods often include object discovery agents, that are used during an off-line development phase, that automatically scan schemas from application data sources, interact with a user's selection, and then produce business object definitions (BODs) that include mapping information between object attributes and data fields in the application data sources. The integration methods and application adapters of these conventional methods must subscribe in advance the pre-defined business object definitions, and can only exchange business objects of the business object definitions.

### SUMMARY OF THE INVENTION

There are several problems with this approach. Business process collaborations must be written based on these pre-defined business object definitions to take advantage of the embedded mapping information. However, changes in business object definitions often render these collaborations useless.

Additionally, these conventional approaches tend to generate business object definitions that include large numbers of data entries in order to be comprehensive and in anticipation of worst case needs.

Further, the developers of business processes and collaborations need to pay special attention when choosing from and fitting results into these pre-defined business object definitions, because the application adapter may not be flexible enough to accept arbitrary business objects due to its subscription to pre-defined business object definitions.

Additionally, applications may need to subscribe to a large number of similar business object definitions. Subscription to a large number of business object definitions may cause problems with maintenance and may slow an event matching process when a business object is received.

In view of the foregoing and other exemplary problems, drawbacks, and disadvantages of the conventional methods and structures, exemplary embodiments of the present invention provide systems and methods for enhancing broker and adapter services and discovering mapping information for business objects during runtime.

In a first exemplary aspect of the present invention, a method of discovering business object definitions includes receiving a business object and a collaboration code, and determining a business object definition for the business object based upon the collaboration code.

In a second exemplary aspect of the present invention, a system for discovering a business object definition includes means for receiving a business object and a collaboration code, and means for determining a business object definition for the business object based upon the collaboration code.

In a third exemplary aspect of the present invention, a business object collaboration system includes a broker that receives a first business object and a first business object definition and that generates a second business object using a collaboration code, a reverse object discovery agent that receives the second business object and the collaboration code, that discovers a second business object definition, and an application adapter that receives the second business object and the second business object definition from the reverse object discovery agent.

In a fourth exemplary aspect of the present invention, a method of business object collaboration includes receiving a business object, determining whether the business object conforms to a known business object definition, forwarding the business object if the business object conforms to a known business object definition, if the business object does not conform to a known business object definition, then requesting a collaboration code and an input business object definition, analyzing the collaboration code and the input business object definition, and creating a new business object definition based upon the results of the analyzing.

In a fifth exemplary aspect of the present invention, a method for deploying computing infrastructure, includes integrating computer-readable code into a computing system. The computer-readable code includes instructions for receiving a business object and a collaboration code, and instructions for determining a business object definition for the business object based upon the collaboration code.

These and many other advantages may be achieved with the present invention.

An exemplary embodiment of the present invention provides a mechanism that is capable of dynamically discovering the mapping of a business object during runtime, as opposed to discovering the mapping during off-line development time. Both the data attributes and the associated mapping information are derived from 1) existing business object definitions and 2) dynamic business logic or process collaboration.

In this case, there are no or fewer pre-defined business object definitions in comparison to conventional methods and systems.

In an exemplary embodiment of the present invention, before a business object is sent to an application, the business object is intercepted by a reverse object discovery agent (RODA). The reverse object discovery agent may perform any or all of the following tasks before sending the result business object with the dynamically discovered business object definition to the application:

Construct a business object definition from the business object;

Semantically analyze a business process collaboration to determine how a business object was processed and merged;

Match and fill the business object definition with mapping information based upon the input business object, business object definition and business process collaboration; and

Send the new dynamically created business object definition to an application adapter. The application adapter then refreshes its business object definition subscription list and is then capable of processing the new business objects based on the data source mapping information embedded in the newly generated business object definition.

An advantage of an exemplary embodiment of the present invention is that business process collaboration codes and application adapters do not need to include a large number of pre-defined business object definitions. Therefore, business process collaboration code composition is simplified, because there is no need to adapt the collaboration code to accept a large number of pre-defined business object definitions.

Rather, with an exemplary embodiment of the present invention, application adapters may dynamically process and subscribe business objects whose types or business objects as they are discovered and defined during runtime.

Additionally, with an exemplary embodiment of the present invention, streaming of a large number of business objects is possible because a large number of smaller, newly created, business object definitions may be provided.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 is a schematic diagram that illustrates a conventional business object collaboration system 160;

FIG. 2 is a schematic diagram that illustrates one exemplary embodiment of a business object collaboration system 200 in accordance with the present invention;

FIG. 3 is a flowchart of one exemplary embodiment of a control routine 300 for a reverse object discovery agent in accordance with the present invention;

FIG. 4 is another schematic diagram that illustrates a routine 400 for generating business objects in accordance with an exemplary embodiment of the present invention;

FIG. 5 illustrates three exemplary business object definitions 552, 554, 556;

FIG. 6 illustrates an exemplary business object definition discovery system 600 incorporating the present invention; and

FIG. 7 illustrates a signal bearing medium 700 (e.g., storage medium) for storing steps of a program of a method according to the present invention.

### DETAILED DESCRIPTION OF PREFERRED EMBODIMENTS OF THE INVENTION

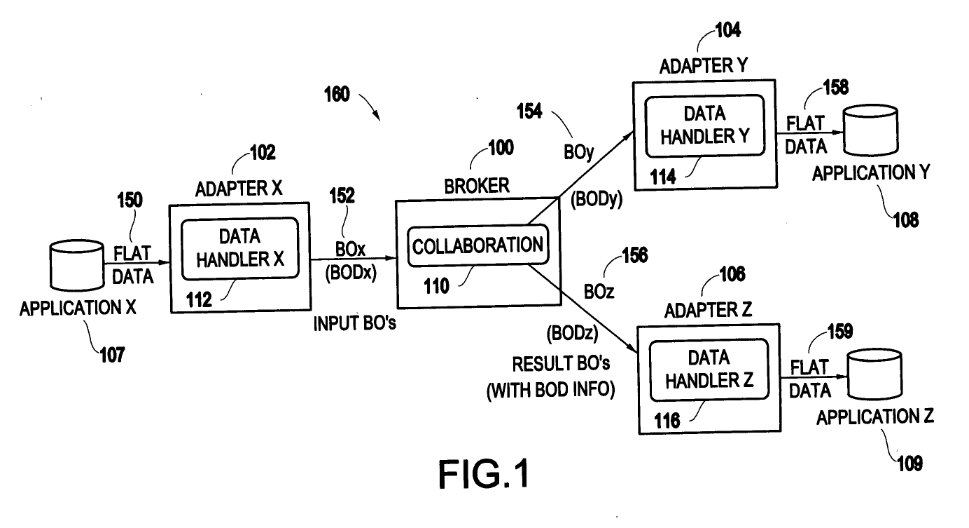

Referring now to the drawings, and more particularly to FIGS. 1-7, there are shown exemplary embodiments of the method and structures of the present invention.

FIG. 1 is a schematic diagram that illustrates a conventional business object collaboration system 160. The business object collaboration system 160 includes a broker 100 and three adapters: Adapter X 102, Adapter Y 104, and Adapter Z 106. Each of these adapters connects to an application and/or a database (e.g., 107, 108, or 109).

Operation of the conventional business object collaboration system 160 is described below.

Initially, the three adapters 102, 104, 106 request and receive business object definition subscription lists from the broker 100, for matching incoming business objects during runtime. The Adapter X 102 then receives data 150 from Application X 107. The data 150 being generated and sent because, as an example, the Application X 107 updates its own database. Adapter X 102 uses a Data Handler X 112 to convert the data 150 into a business object BOx 152 with a format conforming to BODx. Business object BOx 152 triggers a collaboration 110 running in the broker 100 to generate two new business objects BOy 154 and BOz 156 each having business object definitions BODy and BODz, respectively. For purposes of this explanation, the business object BOx 152 is called the input business object, and business object BOy 154 and business object BOz 156 are called output business objects. In other words, the terms (input and output) are with respect to the broker 100.

Business object definition BODy is known to and subscribed by Adapter Y 104, while business object definition BODz is known to and subscribed by Adapter Z 106. Therefore, Adapter Y 104 and Adapter Z 106 can process business object BOy 154 and business object BOz 156, respectively.

Data Handler Y 114 in Adapter Y 104 then converts business object BOy 154 to data 158, which is forwarded to Application Y 108. Adapter Z 106 similarly processes business object BOz 156.

There are several problems with this approach. Business process collaborations must be written based on these pre-defined business object definitions to take advantage of the embedded mapping information. However, changes in business object definitions often render these collaborations useless.

Additionally, these conventional approaches tend to generate business object definitions that include large numbers of data entries in order to be comprehensive and in anticipation of worst case needs.

Further, the developers of business processes and collaborations need to pay special attention when choosing from and fitting results into these pre-defined business object definitions, because the application adapter may not be flexible enough to accept arbitrary business objects due to its subscription to pre-defined business object definitions.

Additionally, applications may need to subscribe to a large number of similar business object definitions. Subscription to a large number of business object definitions may cause problems with maintenance and may slow an event matching process when a business object is received.

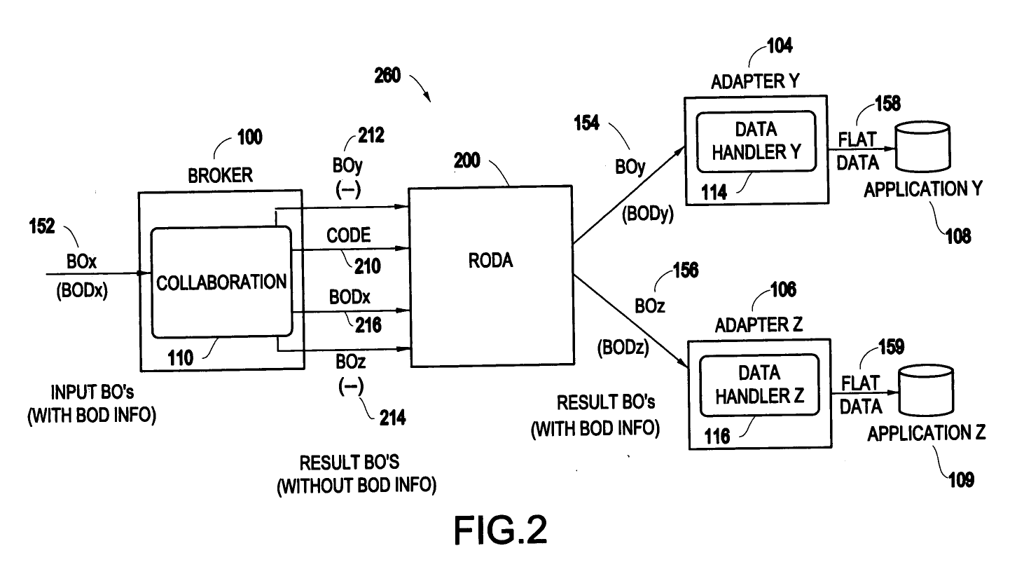

FIG. 2 is a schematic diagram that illustrates one exemplary embodiment of a business object collaboration system 260 in accordance with the present invention. Those reference numbers in FIG. 2 that are the same as those in FIG. 1 refer to similar features and, therefore, description of those features are not repeated in reference to FIG. 2. The business object collaboration system 260 includes a reverse object discovery agent (RODA) that is positioned between the broker 100 and the adapters 104 and 106.

Operation of the business object collaboration system 260 is described below.

In an exemplary scenario, the collaboration 110 running in the broker 100 is capable of producing business objects that are based upon business object definitions that are not predefined by the collaboration 110. In other words, the broker 100 is capable of generating business objects that are defined by newly discovered business object definitions (e.g., during runtime). In this example, the broker 100 generates business objects BOy 212 and BOz 214 that do not have corresponding previously defined business object definitions.

Since Adapter Y 104 and Adapter Z 106 can only handle business objects with known business object definitions and mapping information, the reverse object discovery agent discovers and provides the information during runtime that may be missing from the information that is provided by the broker 100.

The reverse object discovery agent 200 receives a collaboration code 210 from the broker 100 along with the business object definition BODx 216 and uses that information to discover the corresponding business object definitions for each of the business objects BOy and BOz that were also provided by the broker 100. The collaboration code 210 provides an indication as to how the business object BOx was processed to obtain the business objects BOy and BOz.

The reverse object discovery agent 200 may then determine the structures of the business object definitions BODs (BODy and BODz) by converting the structures of the resulting business objects BOs (BOy and BOz) directly, or by examining the instructions that create the resulting business objects BOs. The mapping information may come from the mapping information of the corresponding attributes in the individual input business object definitions BODs, and the newly created attributes due to the collaboration code.

The reverse object discovery agent 200 then provides the business objects BOy 154 and BOz along with the corresponding business object definitions BODy and BODz to the corresponding adapters. The reverse object discovery agent 200 may also provide multiple business object definitions in parallel.

In an exemplary embodiment, the reverse object discovery agent 200 may process the input business objects one at a time. For example, the reverse object discovery agent 200 processes BOy 212 before BOz 214, or BOz 214 before BOy 212, based upon the order of their receipt.

In another exemplary embodiment, one of the business object definitions may be given priority over another, or a priority could be shifted in a round-robin order.

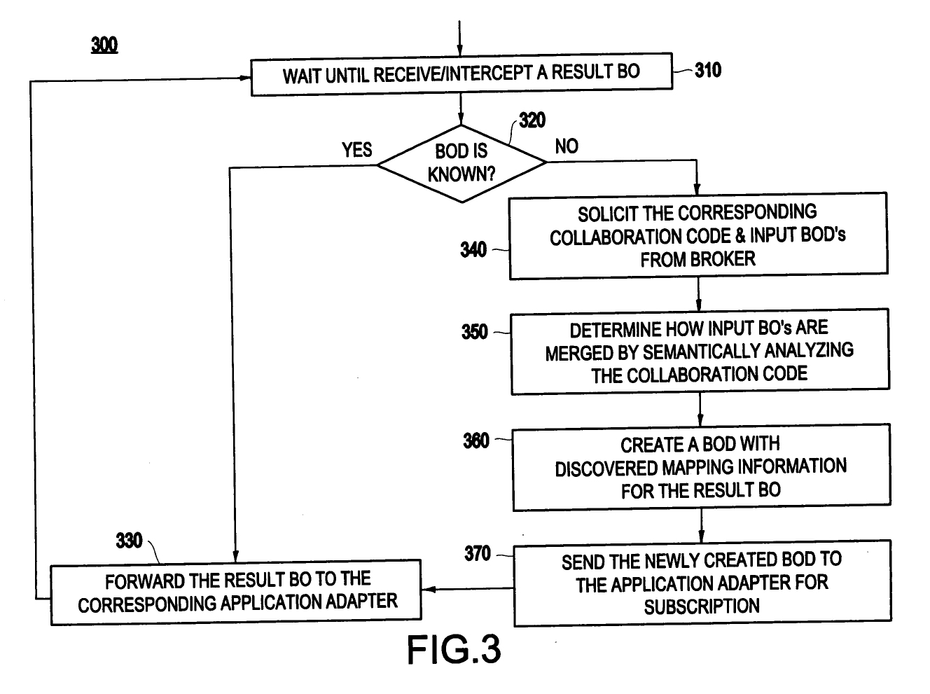

FIG. 3 is a flowchart of one exemplary embodiment of a control routine for a reverse object discovery agent in accordance with the present invention. The control routine starts at step 310 where the reverse object discovery agent idles and waits until it receives or intercepts a business object. Then, in step 320, the reverse object discovery agent determines whether the business object definition for the business object conforms to any known business object definition.

If, in step 320 the reverse object discovery agent determines that the business object conforms to a known business object definition, then the control routine for the reverse object discovery agent continues to step 330. In step 330, the reverse object discovery agent forwards the business object to the corresponding application adapter.

If, however, in step 320, the reverse object discovery agent determines that the business object does not conform to a known business object definition, then the control routine for the reverse object discovery agent continues to step 340. In step 340, the reverse object discovery agent requests the corresponding collaboration code (that produced the output business object) and the input business object definition from the broker.

Then, in step 350, the reverse object discovery agent determines how the business object that was provided to the broker was processed and merged to create the business object(s) that were received by the reverse object discovery agent. In this manner, the reverse object discovery agent discovers the mapping information that was used by the broker to generate the business object(s) that was received by the reverse object discovery agent.

The control routine 300 for the reverse object discovery agent then continues to step 360 where the reverse object discovery agent creates a business object definition based upon the discovered mapping information and continues to step 370. In step 370, the reverse object discovery agent sends the newly created business object definition to an adapter and continues to step 330.

The adapter that receives the newly discovered business object definition may then subscribe to the new business object definition to receive business objects that are defined by the subscribed business object definition.

Thus, in this manner, a collaboration code may generate business objects without pre-defined business object definitions.

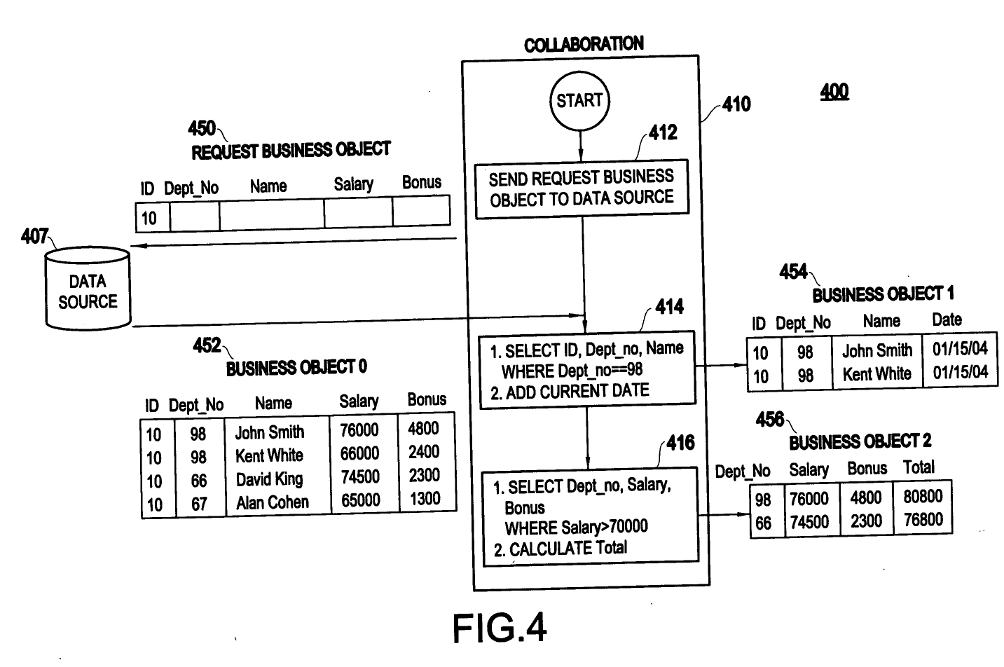

FIG. 4 is another schematic diagram that illustrates an exemplary routine 400 for generating business objects in accordance with an exemplary embodiment of the present invention. In step 412, the collaboration code 410 sends a request business object 450 to data source 407 to retrieve all the employee records under division ID “10.” In response, the data source 407 generates a business object 0 that includes four records that each correspond to the division ID “10” and provides that business object 0 to the collaboration code 410.

Then, in step 414, the broker generates business object 1 454 by selecting all the employee records that correspond to department “98”, removes the salary and bonus data, and adds the current date. Subsequently, in step 416, the collaboration code 410 selects all the employee records with salary “above 70,000,” removes the ID and name columns, calculates the total income for each selected employee, and stores the results as business object 2 456. In this scenario, request business object 450 and business object 0 452 share the same pre-defined BOD (not shown).

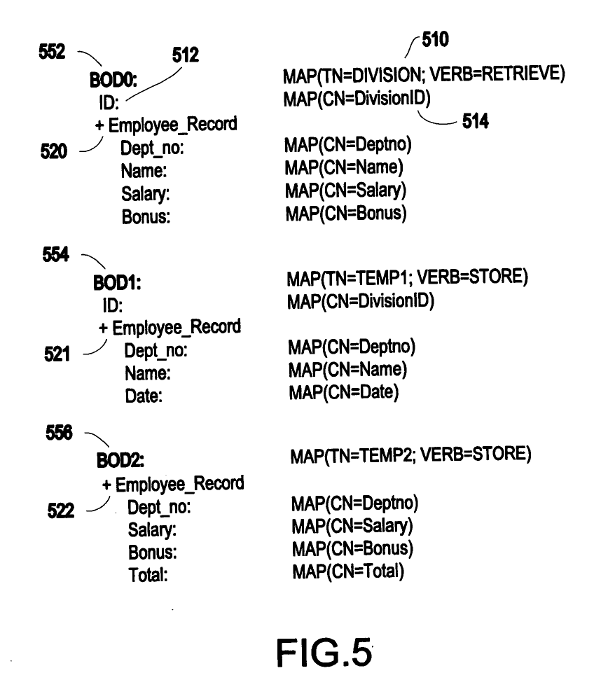

FIG. 5 illustrates three exemplary business object definitions: business object definition BOD0 552, business object definition BOD1 554, and business object definition BOD2 556, which are used to generate business object 0 452, business object 1 454, and business object 2 456, respectively.

In this example, business object definition BOD0 552 is pre-defined by the collaboration code, while the other two business object definitions are dynamically created using, for example, the control routine described above with reference to FIG. 3.

As shown in FIG. 5, business object definition BOD0 552 may include an ID attribute 512 and a structure “Employee_Record” 520. The ID attribute 512 maps to the column of table name “DIVISION” with a column name “DivisionID” 514. The “Employee_Record” structure 520 may include four attributes, such as, for example: Dept_no, Name, Salary, and Bonus, that map to columns Deptno, Name, Salary, and Bonus, respectively via the mapping construct “CN=.” The “+” sign 520 indicates that the structure can occur more than once in a business object instance.

The mapping information in the business object definition provides an application adapter specific instructions about composing (or storing) business objects from (or into) the application data source. As an example, in FIG. 5, the mapping information 510 “(TN=DIVISION;VERB=RETRIEVE)” in business object definition BOD0 directs the application adapter to retrieve all the records from table DIVISION; while the mapping information 514, CN=DivisionID, maps the column name DivisionID of the table DIVISION to the data attribute ID 512 of the business object definition BOD0 552.

As shown by FIG. 4, collaboration code at block 414 first selects from business object 0 452 those records or rows with a value “98” in the “Dept_no” column, and then extracts only the three columns, ID, Dept_no, and Name. Based on the instruction, the reverse object discovery agent may create a partial business object definition BOD with these 3 attributes. Step 2 in the collaboration code at block 414 adds an extra column, “Date,” to create business object 1 454. Based on the instruction, one additional attribute “Date” may be included in the partial business object definition BOD. Therefore, the collaboration code at block 414 indicates that there are four data attributes in business object definition BOD1 554 as shown in FIG. 5. The mapping information is partly copied from business object definition BOD0 552 (for DivisionID, Deptno, and Name), and partly created based on the collaboration code at block 414 (for Date).

The business object definition BOD1 instructs the storage of a table TEMP1, where table TEMP1 includes columns DivisionID, Deptno, Name, and Date.

Similarly, an exemplary embodiment of the present invention may obtain business object 2 456 from business object 0 452 based on the operations at block 416 of the collaboration code 410.

An exemplary embodiment of the present invention provides a mechanism that is capable of dynamically discovering the mapping of a business object during runtime, as opposed to discovering the mapping during off-line development time. Both the data attributes and the associated mapping information may be derived from 1) existing business object definitions and 2) dynamic business logic or process collaboration.

There may be no or fewer pre-defined business object definitions in comparison to conventional methods and systems.

Another advantage of an exemplary embodiment of the present invention is that business process collaboration codes and application adapters do not need to include a large number of pre-defined business object definitions. Therefore, business process collaboration code composition is simplified, because there is no need to adapt the collaboration code to accept a large number of pre-defined business object definitions.

Rather, with an exemplary embodiment of the present invention, application adapters may dynamically process and subscribe business objects whose types or business objects as they are discovered and defined during runtime.

Additionally, with an exemplary embodiment of the present invention, streaming of a large number of business objects is possible because a large number of smaller, newly created, business object definitions may be provided.

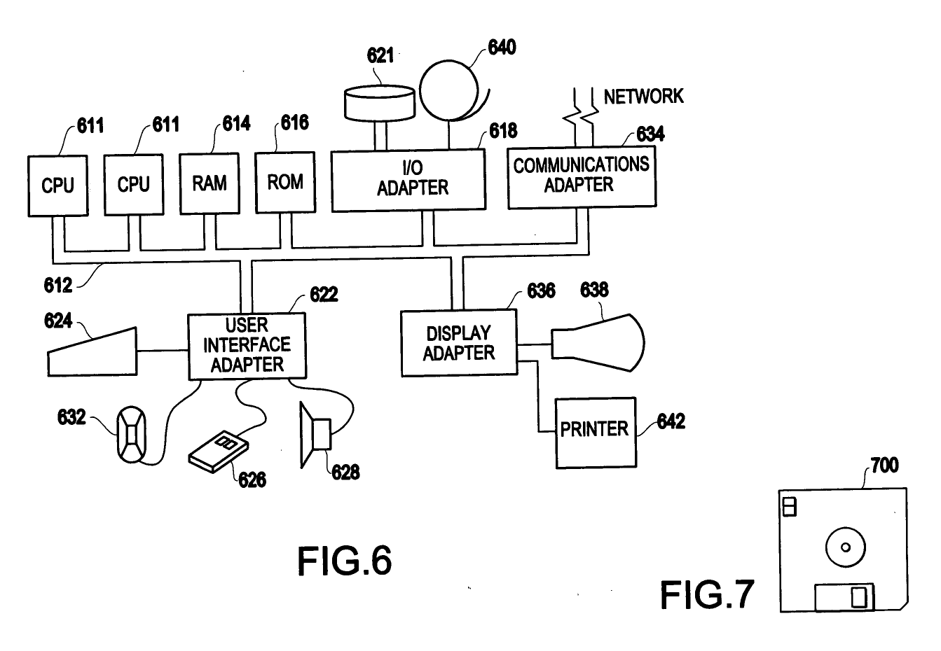

FIG. 6 illustrates a typical hardware configuration of business object definition discovery system for use with the invention and which preferably has at least one processor or central processing unit (CPU) 611.

The CPUs 611 are interconnected via a system bus 612 to a random access memory (RAM) 614, read-only memory (ROM) 616, input/output (I/O) adapter 618 (for connecting peripheral devices such as disk units 621 and tape drives 640 to the bus 612), user interface adapter 622 (for connecting a keyboard 624, mouse 626, speaker 628, microphone 632, and/or other user interface device to the bus 612), a communication adapter 634 for connecting an information handling system to a data processing network, the Internet, an Intranet, a personal area network (PAN), etc., and a display adapter 636 for connecting the bus 612 to a display device 638 and/or printer 642.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 611, as represented by the fast-access storage for example. Alternatively, the instructions may be contained in another signal-bearing media, such as a magnetic data storage diskette 700 (FIG. 7), directly or indirectly accessible by the CPU 611.

Whether contained in the diskette 700, the computer/CPU 611, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

While the invention has been described in terms of several preferred embodiments, those skilled in the art will recognize that the invention can be practiced with modification within the spirit and scope of the appended claims.

Those skilled in the art will appreciate that while exemplary embodiments of the present invention have been described with reference to three adapters and application that the present invention is applicable to more than three adapters and applications.

While the invention has been described in terms of several exemplary embodiments, those skilled in the art will recognize that the invention can be practiced with modification.

Further, it is noted that, Applicants' intent is to encompass equivalents of all claim elements, even if amended later during prosecution.

1. A method of discovering an object definition, comprising determining an object definition for an object based upon a collaboration code.

2. The method of claim 1, further comprising receiving said object and said collaboration code.

3. The method of claim 1, wherein said object definition comprises a business object definition and said object comprises a business object.

4. The method of claim 1, further comprising forwarding said object and said object definition.

5. The method of claim 4, wherein said forwarding comprises forwarding said object and said object definition to an application adapter.

6. The method of claim 5, further comprising processing said object based upon said object definition in said application adapter.

7. The method of claim 1, wherein said collaboration code determines how data from a second object is mapped to said object.

8. The method of claim 1, wherein said collaboration code determines how said object is derived from said second object.

9. The method of claim 8, wherein said collaboration code determines how said object is derived from said second object and a second object definition.

10. The method of claim 9, further comprising receiving said second object definition.

11. The method of claim 10, wherein said determining comprises determining said object definition for said object based upon said collaboration code and said second object definition.

12. The method of claim 1, wherein said receiving comprises receiving said object and said collaboration code from a broker.

13. A system for discovering an object definition, comprising:
means for receiving an object and a collaboration code; and
means for determining an object definition for said object based upon said collaboration code.

14. The system of claim 13, wherein said object definition comprises a business object definition and said object comprises a business object.

15. The system of claim 13, further comprising means for forwarding said object and said object definition to an application adapter.

16. The system of claim 13, wherein said collaboration code determines how data from a second object is mapped to said object.

17. The system of claim 13, further comprising means for receiving a second object definition, wherein said collaboration code determines how said object is derived from said second object and said second object definition.

18. The system of claim 17, wherein said means for determining comprises means for determining said object definition for said object based upon said collaboration code and said second object definition.

19. The system of claim 13, wherein said means for receiving comprises means for receiving said object and said collaboration code from a broker.

20. An object collaboration system comprising:
a reverse object discovery agent that receives a first object and a collaboration code from a broker and that discovers a first object definition.

21. The system of claim 20, further comprising:
a broker that receives a second object and a second object definition and that generates said first object using said collaboration code.

22. The system of claim 21, wherein said collaboration code determines how said first object is derived from said second object.

23. The system of claim 21, wherein said collaboration code determines how said first object is derived from second object and said second object definition.

24. The system of claim 20, further comprising:
an application adapter that receives said first object and said first object definition from said reverse object discovery agent.

25. A method of object collaboration, comprising
determining whether an object conforms to a known object definition; and
requesting a collaboration code and an input object definition if said object does not conform to a known object definition.

26. The method of claim 25, further comprising analyzing said collaboration code and said input object definition.

27. The method of claim 26, further comprising creating a new object definition based upon the results of said analyzing.

28. The method of claim 25, further comprising forwarding said object if said object conforms to a known object definition.

29. The method of claim 25, wherein said object comprises a business object and said object definition comprises a business object definition.

30. The method of claim 25, further comprising forwarding said new object definition to an application adapter.

31. The method of claim 30, further comprising receiving a subscription from said application adapter for said new object definition.

32. The method of claim 31, further comprising forwarding said object in response to said subscription.

33. A method for deploying computing infrastructure, comprising integrating computer-readable code into a computing system, the computer-readable code comprising:
instructions for receiving an object and a collaboration code; and
instructions for determining an object definition for said object based upon said collaboration code.

34. The method of claim 33, wherein said object comprises a business object and said object definition comprises a business object definition.

35. The method of claim 33, further comprising instructions for forwarding said new object definition to an application adapter.

36. The method of claim 35, further comprising instructions for receiving a subscription from said application adapter for said new object definition.

37. The method of claim 36, further comprising instructions for forwarding said object in response to said subscription.
